(19) United States
(12) Patent Application Publication
(10) Pub. No.: US 2004/0023629 A1
(43) Pub. Date: Feb. 5, 2004

(54) Receiving unit for searching for at least one unused transmission channel in a communications device, and a method for use

(76) Inventor: Otto Klank, Lehrte-Arpke (DE)

Correspondence Address: Joseph S Tripoli, Patent Operations-Thomson multimedia Licensing Inc, CN 5312, Princeton, NJ, 08543-5312, US

(21) Appl. No.: 10/451,294

(22) PCT Filed: Dec. 7, 2001
(86) PCT No.: PCT/EP01/14426

(30) Foreign Application Priority Data
Dec. 20, 2000 (DE) 100 63 515.6

(51) Int. Cl. H04B 1/00

(52) U.S. Cl. 455/130; 455/134

(57) ABSTRACT

The invention relates to a receiving unit for searching for at least one unused transmission channel in a communications device in a network of distributed stations and/or for monitoring transmission channels such that specific messages can be determined for that communications device, and to a method for its use, in particular in a local broadband network or a digital broadband home network. The receiving unit comprises a filter unit (5), which has a broadband reception characteristic in a monitoring mode, such that signals from a number of transmission channels can be received in parallel; a digital filter device (7) for subdividing a broad filter band, which has passed through the filter unit (5), into a number of component signals which each have a narrower bandwidth than broadband signal and can each be associated with one of the number of transmission channels; and an evaluation device (9) in order to determine at least one signal strength for each of the number of component signals so that it is possible to decide which of the number of transmission channels is or are being used and/or which of the number of transmission channels is or are not being used.

The invention relates to a receiving unit for searching for at least one unused transmission channel in a communications device in a network of distributed stations, in particular in a local broadband network or a digital broadband home network, and to a method for use of the receiving unit.

### PRIOR ART

During operation of a local broadband network or of a digital broadband home network, the devices which are integrated in the respective network have to search for transmission channels for transmitting information within the network, and select those which are free or unused at a specific transmission time. These free transmission channels can then be used by the respective network device for data or information transmission, if such transmission is requested.

Furthermore, it is necessary for the devices which are integrated in the network to identify and to select the transmission channels which comprise information which is intended for the respective device in the network. Conventional devices in local broadband networks or digital broadband home networks filter or search for the free transmission channels and for the transmission channels with information for that respective device by means of a method in which the available transmission channels are filtered out successively, and whose usage and/or information content is investigated. This method means that the evaluation of the transmission channels consumes a considerable amount of time. The times required for this purpose lead to the transmission of the information within the respective network being delayed.

The object of the invention is to provide a receiving unit of the type mentioned initially, and a method for its use, which allows quick and efficient searching for unused transmission channels.

According to the invention, the object is achieved by a receiving unit according to claim 1, and by a method according to claim 6.

According to one aspect of the invention, a receiving unit is provided for searching for an unused transmission channel in a communications device in a network of distributed stations, in particular in a local broadband network or a digital broadband home network. The receiving unit comprises a filter unit which has a broadband reception characteristic in a monitoring mode, so that signals from a number of transmission channels can be received in parallel; a digital filter device for subdividing a broadband signal, which has passed through the filter unit, into a number of component signals which have a narrow bandwidth and can each be associated with one of a number of transmission channels; and an evaluation device in order to determine at least one signal strength for each of the number of component signals which have been filtered out so that it is possible to decide which of the number of transmission channels is or are being used and/or which of the number of transmission channels is or are not being used.

According to a further aspect of the invention, a method is provided for searching for an unused transmission channel in a communications device in a network or distributed stations, in particular in a local broadband network or a digital broadband home network. The method comprises the following steps:

reception of signals from a number of transmission channels in a broad frequency band by means of a filter unit having a broadband transmission characteristic in a monitoring mode;

subdivision of a broad filter band, which is passed through the filter unit, into a number of components by means of a digital filter device, with the number of components having a narrower bandwidth than the broad frequency band;

respective association of the number of component signals with one of the number of transmission channels; and

analysis of at least one of the number of component signals, at least with respect to a signal intensity by means of an evaluation device, in which a distinction is drawn between which of the number of transmission channels is or are being used and/or which of the number of transmission channels is or are not being used.

The invention comprises the essential fundamental idea of designing the receiving unit such that the signals from different transmission channels can be received at the same time. The signals received in a broad frequency band can then be subdivided by means of a digital filter device into a number of frequency ranges, which are each associated with one transmission channel. The number of frequency ranges are then analysed by means of an evaluation device, so that unused or free transmission channels are determined. The receiving unit, and hence the communications device, can use the information relating to unused transmission channels to react without delay to a request for use of one or more transmission channels. After receiving the usage request, it is not necessary, as envisaged in the prior art, to check individually and successively whether the transmission channels available in the respective network are being used.

The response times in the respective network are considerably shorter by means of the proposed receiving unit and the method for its use.

The information about used/unused transmission channels can expediently be used, in a development of the invention, by the receiving unit having selection means for selecting the unused transmission channel or all the unused transmission channels, for signal transmission and/or for forming a network element within the network of distributed stations, when a usage request is detected.

One refinement of the invention, which is preferred with regard to flexible usefulness of the receiving unit, can provide for the filter unit to be a switchable filter unit, which can be switched between the monitoring mode and a normal mode by means of a switching signal, with the filter unit having a narrower bandwidth transmission characteristic when in the normal mode than in the monitoring mode, so that signals of at least one selected transmission channel of the number of transmission channels can be selectively filtered out.

In order to extend the application options of the receiving unit according to the invention, an expedient development of the invention can provide for the receiving unit to have an analysis device for analysing the number of signal elements, such that it is possible to determine whether the number of signal elements comprise information which can be processed by that communications device, and whether the information which can be processed by that communications device is intended for that communications device.

Reception of the signals from an individual transmission channel and simultaneous reception of the signals from a number of transmission channels using different filter units can be achieved, in one expedient development of the invention, by the filter unit having a number of filter components, with one filter component having a broadband transmission characteristic which covers a number of transmission channels, and another filter component having a narrower transmission characteristic, which covers only one transmission channel.

The method claims have advantages corresponding to those described in conjunction with the associated apparatus claims.

### DRAWING

The invention will be explained in more detail in the following text using exemplary embodiments and with reference to a drawing, in which:

FIG. 1 shows a schematic block diagram of a receiving unit for a communications device;

FIG. 2 shows a schematic block diagram of a further receiving unit for a communications device; and

FIG. 3 shows an embodiment of a switchable filter unit.

### EXEMPLARY EMBODIMENTS

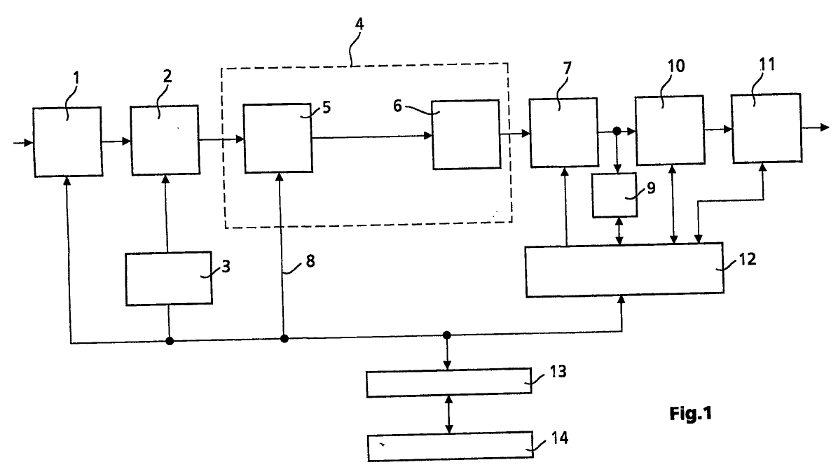

FIG. 1 shows a schematic block diagram of a receiving unit for a communications device, which can be integrated as a transmitting, receiving or transmitting/receiving device in a network of distributed stations, in particular in a local broadband network or a digital broadband home network. If the communications device is intended to be included in an information interchange in the network at a specific time, as is confirmed in this case in the communications device by a usage request being received, then the communications device has the task of searching for a transmission channel for the information interchange, which transmission channel is free at the specific time at which the involvement of the communications device takes place, that is to say is available for the information or data interchange.

The usage request can in this case be produced either by a user of the communications device or by one of the other distributed stations in the network. The steps to be carried out initially match one another in both cases, that is to say a usage request by the user and a usage request by the other station. Depending on the information initially obtained about the transmission channels, for example in the course of a power measurement relating to the transmission channels, the steps carried out after this may, however, differ for the said cases of usage requests.

The receiving unit in the communications device receives signals from a number of transmission channels via a receiving stage 1, preferably a radio-frequency amplifier with a relatively broad tuneable filter. The received signals are then mixed to a first intermediate frequency range in a mixing stage 2 for conversion of radio-frequency signals and, in a subsequent circuit part 4 which is an intermediate frequency amplification stage 5 and an analogue-digital converter unit 6, are changed to the desired frequency. Further mixing stages (not illustrated) may also be provided, if required, in order to obtain the desired frequency. The mixing stage 2 is connected to an oscillator device 3, whose frequency is variable and controllable. The frequency of the oscillator device 3 can thus be used to determine which transmission channel or which part of a frequency range will be supplied to the circuit part 4, and will be filtered out by it.

The received, mixed signals are then passed to the circuit part 4, which comprises a filter unit 5 with amplification elements and an analogue/digital converter device 6. A switching signal 8 can be used to switch the filter unit 5 between a monitoring mode and a normal mode. In the monitoring mode, the filter unit 5 has a broadband reception or transmission characteristic, so that the signals from a number of transmission channels are passed through, in a broad frequency band. In the normal mode, the filter unit 5 has a reception characteristic with a narrower bandwidth than the reception characteristic in the monitoring mode. In this case, only the signals from one selected transmission channel are essentially passed through. Depending on the application, the filter unit 5 can be switched between the two modes by means of the switching signal 8.

The signals which pass through the filter unit 5 are then converted to digital signals, by means of the analogue/digital converter device 6. The digital signals are then subdivided into a number of frequency ranges or component signals by means of the digital filter device 7, and these have a narrower bandwidth than the broad frequency band which is passed through the filter unit 5 in the monitoring mode. The number of component signals in this case have a bandwidth which corresponds to the bandwidth of one transmission channel in the communications device. The number of component signals are each associated with one block of a number of transmission channels, from which signals are received via the input stage 1.

The bandwidth and frequency of the digital filter device 7 are variable and controllable, and the digital filter device 7 is implemented, for example, by means of digital signal processors, and can preferably provide a number of parallel output signals. In the normal mode, the digital filter device 7 has a bandwidth which is somewhat wider than the bandwidth of one transmission channel in the network of distributed stations.

In the monitoring mode, the number of component signals can then be analysed by means of an evaluation device 9, in order to find out which of the transmission channels is/are being used or is/are free. In this case, the number of signal elements can be processed in a number of steps, although these steps are carried out sufficiently quickly that parallel processing can be carried out in an appropriate manner. An appropriately powerful processor is then required for this purpose. The evaluation device 9 is used, for example, to determine a power level which is in each case associated with a number of signal elements and in each case represents one received power level, in which case other parameters characterizing the signal elements can also be evaluated by means of the evaluation device 9.

The received power level can in this case be determined relatively easily, as follows. The absolute values of the samples after A/D conversion are added for the relevant signal section. This provides a direct measure of the signal strength. Another refinement can provide for FFT transformation to be carried out first of all on the samples in that signal section. The signal amplitude can then be read in the resultant spectrum. However, this solution is considerably more complex.

On the basis of the information about transmission channels which are being used or are not being used, the communications device can then decide, in the event of a usage request for transmission of information via one or more transmission channels, whether and which transmission channels can be made available for that usage request. A selection device (not illustrated) is provided for this purpose, which processes the information detected by means of the evaluation device 9, in order to select at least one free transmission channel.

The selection device is part of a control unit 12 or a central control unit 13. In particular, the control unit 12 provides required clock and filter control signals, for example for filter coefficients, communicates with the central control unit 13, and can carry out further evaluation processes in conjunction with signals from a demodulation device 10 and from a channel decoder device 11. The central control device 13 controls, in particular, the transmission and reception processes, and defines a transmission channel to be used, for example on the basis of information from the control unit 12 about unused transmission channels. Appropriate selection signals are passed via the control unit 12 to the demodulation unit 10. The transmission channel to be used can be used for transmission and reception using what is referred to as the “time-sharing” method.

The number of component signals which are emitted from the digital filter device 7 may be analysed, for example on the basis of a determined signal strength or power. However, any desired parameters or signal characteristics may be evaluated which can be used to distinguish between transmission channels that are being used and those which are not being used.

The information about transmission channels which are being used and are not being used can also be used to make an initial selection of transmission channels. Furthermore, transmission channels which contain signals can be subjected to more detailed analysis, in particular in order to characterize the signals contained in them. Correlation methods can be used to check the component signals for the presence of known, periodically transmitted (test) sequences.

The respective component signals can be analysed in any desired manner after being output from the digital filter device 7. This may be done, for example, using the demodulation device 10, which is provided for normal operation, and the channel decoder device 11. The channel decoder device 11 carries out the appropriate decoding process for the communications device, for example error correction. The demodulation device 10 carries out a demodulation process which is appropriate for the communications device on the previously filtered and converted signal, for example quadrature phase demodulation (QPSK) or quadrature phase/amplitude demodulation (QAM) on the signals.

If only the evaluation unit 9 or only the demodulation device 10 is provided, the further analysis of the component signals can be carried out only individually and in a number of steps. However, if the configuration of the evaluation unit 9 or of the demodulation device 10 is appropriate and the component signals are buffer-stored, it is possible, however, to process the component signals using a clock rate which is faster than the data rate in an individual transmission channel, so that an entire block of component signals can be analysed in a time which corresponds to the analysis of an individual component signal with a normal clock rate.

In the normal mode, the filter device 5 is operated with a narrow bandwidth, and the digital filter device 7 is likewise set for receiving the signal in only one transmission channel. After filtering, the signal is passed for further processing to the demodulation device 10 and to the channel decoder device 11 (see FIG. 1).

The further analysis of the signals in the normal mode and of the signal elements in the monitoring mode can be used, in particular, to find out whether the analysed signals are in a format appropriate to the communications device and/or have information which can be processed by and is intended for this communications device, for example a usage request from a user or from another station in the network.

The digital filter device 7, the evaluation device 9, the channel decoder device 11 and the demodulation device 10 are each connected to the control unit 12, which is coupled, together with the oscillator device 3, to the central control unit 13.

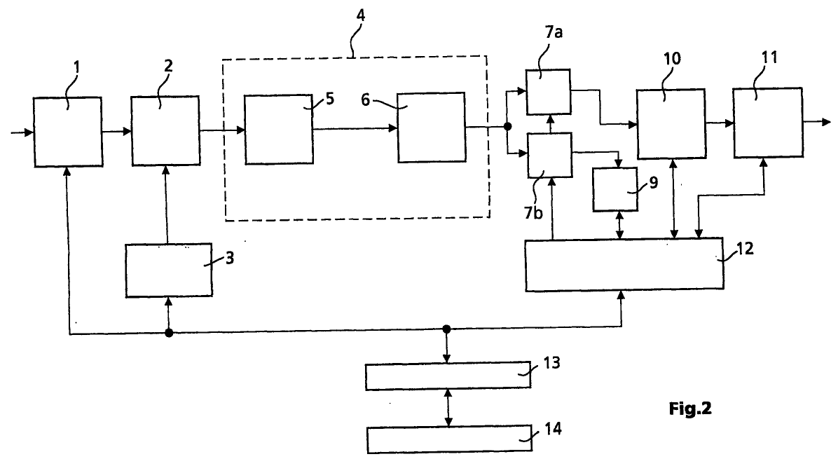

FIG. 2 shows, schematically, a further receiving unit in a communications device, in which the digital filter device 7 is replaced by filter components 7a, 7b. The filter component 7b has a transmission characteristic which corresponds to the transmission characteristic of the digital filter device 7 in the monitoring mode, as has been described in conjunction with FIG. 1. The other filter component 7a has a transmission characteristic which corresponds to the transmission characteristic of the digital filter device 7 in the normal mode (see the description in conjunction with FIG. 1). The output signals from the filter component 7b are supplied to the evaluation device 9. The output signals from the filter component 7a are coupled to the demodulation device 10.

It is thus possible by means of the receiving unit illustrated schematically in FIG. 2 not only to selectively receive the signals in one transmission channel but also, in parallel, to carry out a broadband reception process in order to search for a free transmission channel, as has been described in conjunction with the monitoring mode for the receiving unit as shown in FIG. 1. However, in this case, it is only possible to monitor various transmission channels which are grouped around the transmission channel set in the filter 7a, since all the signals have to pass through the filter device 5 at the same time.

In each of the embodiments shown in FIG. 1 and FIG. 2, the central control unit 13 is connected to a transmission section 14 of the communications device, with the receiving section comprising the elements annotated by the reference symbols 1 to 12.

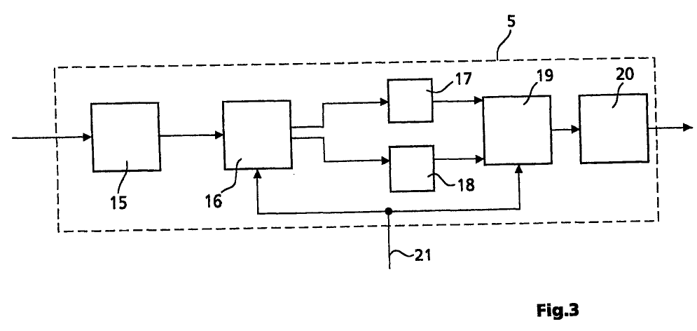

In a further embodiment (see FIG. 3), two separate filters 17, 18 are provided instead of the switchable filter unit 5, with one filter 17 having a bandwidth corresponding to one transmission channel and, for example, being in the form of an SAW filter. The other filter 18 has a relatively broad frequency pass band, covering a number of transmission channels, and may likewise be in the form of an SAW filter.

In this case, as shown in FIG. 3, amplifier elements 15, 20 as well as changeover switches or power dividers 16, 19 are also provided, and are used for combination of the signals. If the changeover switches 16, 29 are present, a further switching signal 21 is required, and essentially corresponds to the switching signal 8.

Furthermore, it is possible to provide an embodiment which is advantageous in terms of processing large signals. In this case, two parallel paths are provided (not illustrated) in the filter device 5 and in the analogue/digital converter device 6, with a narrow and a broad transmission characteristic.

Furthermore, the analogue/digital converter device 6 may be arranged upstream of the filter device 5, in the direction in which the received signals are processed. The filter device, like the filter device 7, is then designed using digital technology, or is combined with the digital filter device 7.

1. Receiving unit for searching for at least one unused transfer channel in a communications device in a network of distributed stations, in particular in a local broadband network or a digital broadband home network, characterized by a switchable filter unit (5), which can be switched between a monitoring mode and a normal mode by means of a switching signal (8), the switchable filter unit (5) having a broadband reception characteristic in the monitoring mode, so that signals from a number of transfer channels are received in parallel, and the switchable filter unit (5) having a narrower bandwidth transfer characteristic than in the monitoring mode when in the normal mode, so that signals of at least one selected transfer channel of the number of transfer channels can be selectively filtered out, the receiving unit further characterized by a digital filter device (7) for subdividing a broadband signal, which has passed through the filter unit (5) in monitoring mode, into a number of parallel component signals, which each has a narrower bandwidth than the broadband signal and each being associated with one of a number of transfer channels; the receiving unit being further characterised by an evaluation device (9) for determining at least one signal strength for each of the number of component signals so that it is possible to decide which of the number of transfer channels is or are being used and/or which of the number of transfer channels is or are not being used.

2. Receiving unit according to claim 1, characterized by selection means for selecting the unused transfer channel or all the unused transfer channels for signal transfer, and/or for forming a network element within the network of distributed stations when a usage request is detected.

3. Receiving unit according to claim 1 or 2, characterized by an analysis device for analysing the number of component signals, in order to determine whether the number of component signals comprise information which can be processed by the communications device, and whether the information which can be processed by the communications device is intended for that communications device.

4. Receiving unit according to one of the preceding claims, characterized in that the switchable filter unit (5) comprises a number of filter components (15-20), with one filter component (18) having a broadband transfer characteristic which covers a number of transfer channels, is and another filter component (17) having a narrower transfer characteristic, which covers only one transfer channel.

5. Method for searching for at least one unused transfer channel in a communications device in a network of distributed stations, in particular in a local broadband network or a digital broadband home network, with the communications device comprising a receiving unit according to one of claims 1 to 4, and the method having the following method steps:
reception of signals from a number of transfer channels in a broad frequency band by means of a switchable filter unit (5) having a broadband transfer characteristic in a monitoring mode and a narrower transfer characteristic in a normal operation mode;
subdivision of a broad filter band, which is passed through the filter unit (5) switched into monitoring mode, into a number of parallel component signals by means of a digital filter device (7), with the number of component signals having a narrower bandwidth than the broad frequency band;
respective association of the number of component signals with one of the number of transfer channels; and
analysis of at least one of the number of component signals, at least with respect to a signal intensity by means of an evaluation device (9), in which a distinction is drawn between which of the number of transfer channels is or are being used and/or which of the number of transfer channels is or are not being used.

6. Method according to claim 7, characterized in that the unused transfer channel, or the number of unused transfer channels, is or are selected by means of selection means for signal transfer and/or for formation of a network element, when the receiving unit receives a usage request.

7. Method according to claim 5 or 6, characterized in that the filter unit (5) is switched to a normal mode by means of a switching signal (8), in which normal mode the filter unit (5) has a narrower bandwidth transmission characteristic than that in the monitoring mode, so that signals of at least one selected transmission channel of the number of transmission channels are selectively received.

8. Method according to one of claims 5 to 7, characterized in that the search for the at least one unused transfer channel is repeated at predetermined time intervals.

9. Method according to one of claims 5 to 8, characterized in that each of the component signals in the transfer channel that is being used, or in all the transfer channels which are being used, is analysed by means of an analysis device, in order to determine information which is intended for that communications device.

10. Method according to claim 9, characterized in that only the respective component signals of the transfer channel being used or of all the transfer channels being used are analysed which are covered in a network area associated with that communications device.

11. Method according to claim 10, characterized in that the transfer channel or the number of transfer channels which is or are covered by the network area associated with that communications device is or are determined by means of an identifier, which is known to that communications device.

12. Method according to claim 10 or 11, characterized in that a check is carried out to determine whether the transfer channel or the number of transfer channels which is or are covered by the network area associated with that communications device has or have a usable transfer capacity, and is or are selected for use provided sufficient usable transfer capacity has been determined, and there is a usage request.
